(19) United States
(12) Patent Application Publication
(10) Pub. No.: US 2020/0065836 A1
(43) Pub. Date: Feb. 27, 2020

(54) SYSTEM AND METHOD FOR SALES AND DISTRIBUTION MANAGEMENT

(71) Applicant: Marlabs Innovations Private Limited, Bangalore (IN)

(72) Inventors: Satyanarayana Maddipati, Bangalore (IN); Numaan Ahmed Mohammed, Bengaluru (IN); Sudarsan Raja, Bangalore (IN)

(73) Assignee: Marlabs Innovations Private Limited, Bangalore (IN)

(21) Appl. No.: 16/536,373

(22) Filed: Aug. 9, 2019

(30) Foreign Application Priority Data
Aug. 14, 2018 (IN) 201841030576

(51) Int. Cl. G06Q 30/02; G06Q 10/06; G06Q 30/06; G06Q 10/08; G06Q 30/00

(52) U.S. Cl. CPC G06Q 30/0201; G06Q 10/06; G06Q 30/01; G06Q 30/06; G06Q 10/087; G06Q 30/0202

(57) ABSTRACT

A system for sales and distribution management are disclosed. The system includes one or more processors, a target assessment subsystem configured to assign one or more sales leads to at least one sales representative based on one or more parameters, a route plan subsystem configured to generate an optimal route plan for the at least one sales representative to reach the one or more sales leads based on one or more properties, an order fulfilling subsystem configured to fulfill one or more sales orders by the at least one sales representative received from the one or more sales leads and to monitor one or more activities of the at least one sales representative on fulfilling the one or more sales order in real-time, an expense management subsystem configured to process one or more reimbursement requests generated by the at least one sales representative.

### CROSS-REFERENCE TO RELATED APPLICATION

This Application claims priority from a complete patent application filed in India having Patent Application No. 201841030576, filed on 14 day of Aug. 2018 and titled “SYSTEM AND METHOD FOR SALES AND DISTRIBUTION MANAGEMENT”

### FIELD OF INVENTION

Embodiments of the present disclosure relate to sales and distribution management, and more particularly to system and method for sales and distribution management.

### BACKGROUND

Sales management is a type of discipline which is focused on a particular application associated to a sales technique and management of the operations associated with the sales, and also implementing sales techniques in order to reach the organisational targets. Further, distribution management is a process which simplifies and manages each phase of distribution chain from customers, ordering, delivery, payment, inventory, and right through to services management. Many systems with different approaches are being used to manage sales and distribution of products and services.

One such system includes a platform on which sales leads are assigned to corresponding sales representatives based on pre-defined parameters. Further, the activities of the sales leads and the sales representatives are monitored in real-time. Also, the system searches an optimal route for the sales representatives to visit the sales leads at a pre-defined period or frequency based on the parameters. However, in such an approach the system limits itself from enabling a user or an assigner to review the proposed route plan for an approval and re-planning the visit based on the parameters. Also, such system does not allow the user or the assigner to receive and generate sales orders for the sales leads. The system does not even enable the user to process the expense reimbursement request based on the parameters. Henceforth, such a system does not provide an end to end solution for both sales leads and the sales representatives of the organisation, thereby making such system less effective and time consuming.

Hence, there is a need for an improved system and method for sales and distribution management to address the aforementioned issues.

### BRIEF DESCRIPTION

In accordance with one embodiment of the disclosure, a computing device is disclosed. The computing device includes one or more processors. The computing device also includes a target assessment subsystem operable by the one or more processors. The target assessment subsystem is configured to assign one or more sales leads to at least one sales representative based on one or more parameters. The computing device also includes a route plan subsystem operable by the one or more processors. The route plan subsystem is configured to generate an optimal route plan for the at least one sales representative to reach the one or more sales leads based on one or more properties. The computing device also includes an order fulfilling subsystem operable by the one or more processors. The order fulfilling module is configured to fulfill one or more sales orders by the at least one sales representative received from the one or more sales leads. The order fulfilling subsystem is also configured to monitor one or more activities of the at least one sales representative on fulfilling the one or more sales order in real-time. The system also includes an expense management subsystem operable by the one or more processors. The expense management subsystem is configured to process one or more reimbursement requests generated by the at least one sales representative. The computing also includes a notification subsystem operable by the one or more processors. The notification module is configured to generate a notification to the at least one sales representative upon processing the one or more reimbursement requests.

In accordance with one embodiment of the disclosure, a method for sales and distribution management. The method includes assigning one or more sales leads to at least one sales representative based on one or more parameters. The method also includes generating an optimal route plan for the at least one sales representative to reach the one or more sales leads based on one or more properties. The method also includes fulfilling one or more sales orders by the at least one sales representative received from the one or more sales leads. The method also includes monitoring one or more activities of the at least one sales representative on fulfilling the one or more sales order in real-time. The method also includes processing one or more reimbursement requests generated by the at least one sales representative. The method also includes generating a notification to the at least one sales representative upon processing the one or more reimbursement requests.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a computing device in accordance with an embodiment of the present disclosure;

FIG. 2 is a block diagram representation of an exemplary embodiment of a computing device for sales and distribution management of FIG. 1 in accordance with an embodiment of the present disclosure;

FIG. 3 is a block diagram of a general computer or a server in accordance with an embodiment of the present disclosure;

FIG. 4 is a flow chart representing steps involved in a method for sales and distribution management in accordance with an embodiment of the present disclosure;

FIG. 5 is a flow chart representing steps involved in an exemplary method for target assignment within an organization of FIG. 4 in accordance with an embodiment of the present disclosure;

FIG. 6 is a flow chart representing steps involved in another exemplary method for visit plan of FIG. 4 in accordance with an embodiment of the present disclosure;

FIG. 7 is a flow chart representing steps involved in yet another exemplary method for order fulfilling within the organization of FIG. 4 in accordance with an embodiment of the present disclosure; and

FIG. 8 is a flow chart representing steps involved in yet another exemplary method for expense management within the organization of FIG. 4 in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relates to a sales and distribution management platform and a method to operate the same. The computing device includes one or more processors. The computing device also includes a target assessment subsystem operable by the one or more processors. The target assessment subsystem is configured to assign one or more sales leads to at least one sales representative based on one or more parameters. The computing device also includes a route plan subsystem operable by the one or more processors. The route plan subsystem is configured to generate an optimal route plan for the at least one sales representative to reach the one or more sales leads based on one or more properties. The computing device also includes an order fulfilling subsystem operable by the one or more processors. The order fulfilling module is configured to fulfill one or more sales orders by the at least one sales representative received from the one or more sales leads. The order fulfilling subsystem is also configured to monitor one or more activities of the at least one sales representative on fulfilling the one or more sales order in real-time. The computing device also includes an expense management subsystem operable by the one or more processors. The expense management subsystem is configured to process one or more reimbursement requests generated by the at least one sales representative. The computing device also includes a notification subsystem operable by the one or more processors. The notification module is configured to generate a notification to the at least one sales representative upon processing the one or more reimbursement requests.

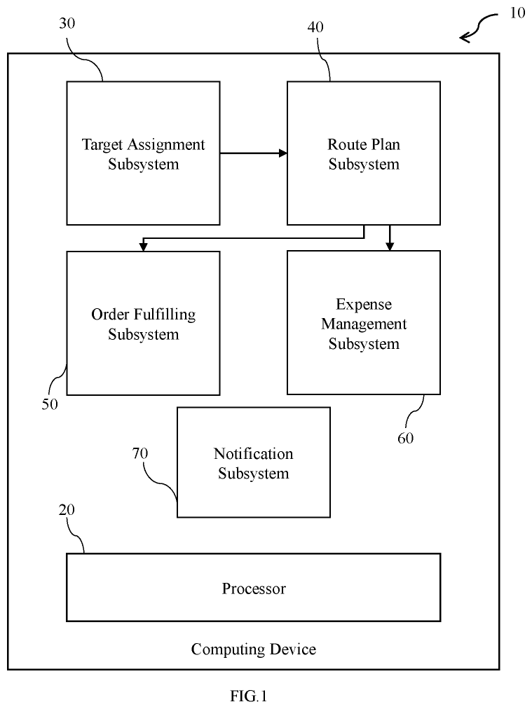

FIG. 1 is a block diagram representation of a computing device 10 in accordance with an embodiment of the present disclosure. The system hereafter referred to as the computing device 10 includes one or more processors 20. The one or more processors 20 includes a target assessment subsystem operable by the one or more processors. The target assessment subsystem 30 is configured to assign one or more sales leads to at least one sales representative based on one or more parameters. As used herein, the term “sales leads” is defined as a person or business who may eventually become a client. Sales lead also refers to the data that identifies an entity as a potential buyer of a product or service. In one embodiment, the one or more sales leads may be one or more customers who may be in need of one or more products or one or more services.

Also, the term “sales representative” is defined as a person who sells products on behalf of a company or an organisation, usually traveling away from their own company's premises to find and sell to customers. In another embodiment, the at least one sales representative may be a service provider, a retailer, a sales person, an executive or the like. In one exemplary embodiment, the one or more parameters may include at least one of a category, availability of time, experience of the at least one sales representative or a combination thereof. In such embodiment, the target assignment subsystem 30 may assign the one or more leads to at least one sales representative based on the one or more parameters and one or more requirements of the corresponding one or more sales leads.

In one exemplary embodiment, the target assessment subsystem 30 may also be configured to monitor one or more activities of the one or more sales leads and the at least one sales representative in real-time. More specifically, upon assigning the one or more sales leads to the at least one sales representative, the target assignment subsystem 30 may monitor the one or more activities of the corresponding one or more sales leads in order to fulfill the one or more requirements of the one or more sales leads in real-time.

Furthermore, the computing device 10 also includes a route plan subsystem 40 operable by the one or more processors 20. The route plan subsystem 40 is configured to generate an optimal route plan for the at least one sales representative to reach the one or more sales leads based on one or more properties. In one embodiment, the route plan subsystem 40 may generate the optimal route plan which may assist the at least one sales representative to communicate with the one or more sales leads in order to fulfill the one or more requirements of the one or more sales leads. In such embodiment, an assigner may view the optimal route plan generated by the route plan subsystem. Consequently, based on certain parameters of the one or more parameters which may be considered by the assigner, the optimal route plan may be altered or changed by the assigner. In such another embodiment, the assigner may provide the one or more parameters to the route plan subsystem 40 and may enable the route plan subsystem 40 to generate a fresh optimal plan.

The computing device 10 also includes an order fulfilling subsystem 50 operable by the one or more processors. The order fulfilling subsystem 50 is configured to fulfill one or more sales orders by the at least one sales representative received from the one or more sales leads. In one embodiment, upon receiving the one or more requirements from the one or more sales leads, the at least one sales representative may perform the one or more activities to fulfill the one or more requirements. In such embodiment, the at least one sales representative may select at least one of price book, shipping address, warehouse and other required details in order to fulfill the one or more sales order received from the one or more sales leads. In one exemplary embodiment, one or more sales order track may be kept open until the one or more sales order is not confirmed by the one or more sales leads upon fulfilling the same by the at least one sales representative.

The order fulfilling subsystem 50 is also configured to monitor the one or more activities of the at least one sales representative on fulfilling the one or more sales order in real-time. In one embodiment, the order fulfillment subsystem 50 may keep a track of how and when the one or more sales orders of the one or more sales leads are being fulfilled by the at least one sales representative based on the optimal route plan finalised.

Furthermore, the computing device 10 also includes an expense management subsystem 60 operable by the one or more processors 20. The expense management subsystem 60 is configured to process one or more reimbursement requests generated by the at least one sales representative. In one embodiment, the at least one sales representative may have had certain expenses while fulfilling the one or more sales order of the one or more sales leads. In such a situation, the at least one sales representative may produce one or more reimbursement requests associated with the expenses of the at least one sales representative. Consequently, the expense management subsystem 60 may process the one or more reimbursement requests produced by the at least one sales representative.

The computing device 10 also includes a notification subsystem 70 operable by the one or more processors 20. The notification subsystem 70 is configured to generate a notification to the at least one sales representative upon processing the one or more reimbursement requests. In one embodiment, upon processing the one or more reimbursement requests produced by the at least one sales representative, the notification subsystem 70 may generate the notification for the same in order to alert or notify an expense department in order to fulfill the one or more reimbursement requests of the at least one sales representative.

In one exemplary embodiment, the computing device 10 also includes a memory not shown in FIG. 1 operatively coupled to the one or more processors 20. The memory is configured to store at least one of a plurality of details of the at least one sales representative, a plurality of details of the one or more sales leads, the optimal route plan, the one or more sales orders, the one or more reimbursement requests, or a combination thereof.

In one exemplary embodiment, the one or more processors 20 along with the memory may be stored on a remote server. In such embodiment, the remote location may be a cloud server. As used herein, the term “cloud server” is defined as a logical server which is built, hosted and delivered through a cloud computing platform over a communication medium such as internet.

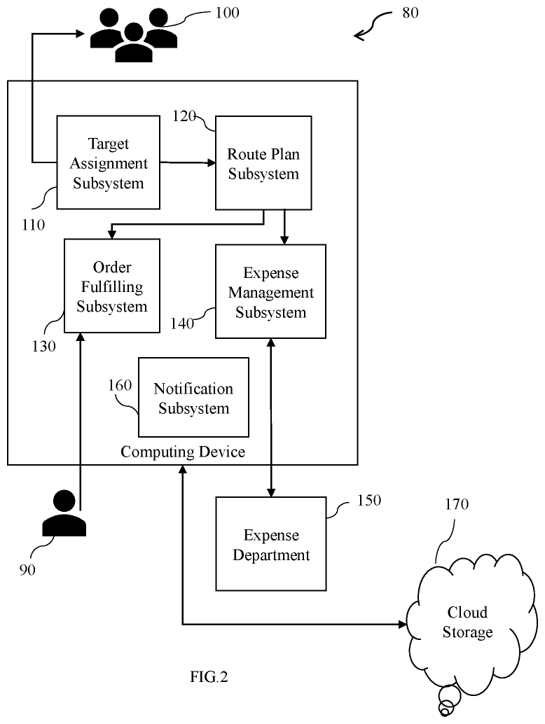

FIG. 2 is a block diagram representation of an exemplary embodiment of a computing device 80 for sales and distribution management of FIG. 1 in accordance with an embodiment of the present disclosure. A sales lead 90 is assigned to a sales representative 100 to manage and fulfill a product delivery order received by the sales lead 90. The computing device 80 includes a target assignment subsystem 110 which is configured to assign the sales lead 90 to the sales representative 100 along with a target which is associated with the sales lead 90.

The sales representative 100 accepts the target assigned by the target assignment subsystem 110. Furthermore, a route plan subsystem 120 generates a route plan for a visit to the sales lead 90. The rout plan is generated based on at least one of a category, availability of time, experience of the at least one sales representative.

Upon receiving the route plan, the sales representative 100 initiates to fulfill the target assigned. The product delivery order from the sales lead 90 is received by an order fulfilling subsystem 130. Furthermore, as the sales representative 100 initiates the assigned target, the order fulfilling subsystem 130 monitors one or more activities of the sales representative 100 while the sales representative 100 is fulfilling the assigned target of delivering the product ordered by the sales lead 90. Furthermore, the sales representative 100 visits an address of the sales lead 90 in order to deliver the product ordered by the sales lead 90. In such a situation, the sales representative 100 may have spent a sum of amount on a couple of expenditures. Consequently, the sales representative 100 applies for a reimbursement request. The reimbursement request is processed by an expense management subsystem 140. The reimbursement request is sent to an expense management team of an expense department 150 to receive an approval for the reimbursement request.

Furthermore, upon receiving the approval from the expense department 150, a notification subsystem 160 generates a notification for the sales representative 100 regarding the approval of the reimbursement request applied by the sales representative 100. Also, a plurality of details such as a plurality of details of the sales representative 100, a plurality of details of the sales lead 90, the route plan, the product orders and the reimbursement request are stored on a cloud storage platform 170.

Furthermore, the target assessment subsystem 110, the route plan subsystem 120, the order fulfilling subsystem 130, the expense management subsystem 140 and the notification subsystem 160 are substantially similar to a target assessment subsystem 30, a route plan subsystem 40, an order fulfilling subsystem 50, a expense management subsystem 60 and a notification subsystem 70 of FIG. 1.

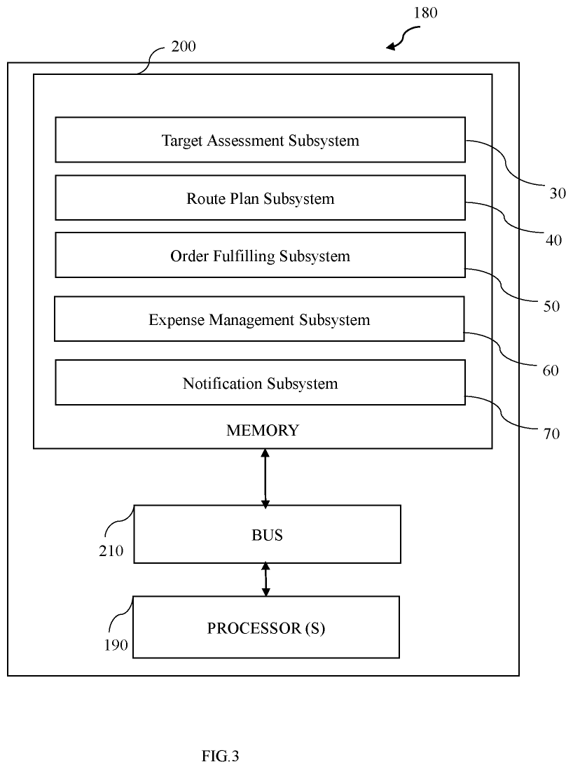

FIG. 3 is a block diagram of a general computer or a server in accordance with an embodiment of the present disclosure. The server 180 includes processors 190, and memory 200 coupled to the processors 180 via a bus 210.

The processors 190, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

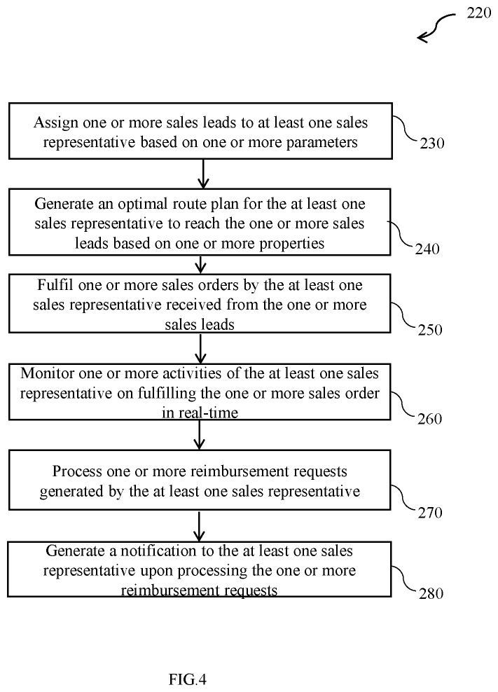

The memory 200 includes a plurality of subsystems stored in the form of executable program which instructs the processor 190 to perform the method steps illustrated in FIG. 4. The memory 200 has following subsystems: the target assignment subsystem 30 configured to assign one or more sales leads to at least one sales representative based on one or more parameters, the route plan subsystem 40 configured to generate an optimal route plan for the at least one sales representative to reach the one or more sales leads based on one or more properties, the order fulfillment subsystem 50 configured fulfill one or more sales orders by the at least one sales representative received from the one or more sales leads and to monitor one or more activities of the at least one sales representative on fulfilling the one or more sales order in real-time, the expense management subsystem 60 configured to process one or more reimbursement requests generated by the at least one sales representative and the notification subsystem 70 generate a notification to the at least one sales representative upon processing the one or more reimbursement requests.

Computer memory elements may include any suitable memory devices for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processors 200.

FIG. 4 is a flow chart representing steps involved in a method 220 for sales and distribution management in accordance with an embodiment of the present disclosure. The method 220 includes assigning one or more sales leads to at least one sales representative based on one or more parameters in step 230. In one embodiment, assigning the one or more sales leads to the at least one sales representative may include assigning one or more sales leads to at least one sales representative based at least one of a category, availability of time, experience of the at least one sales representative or a combination thereof.

In one exemplary embodiment, the method 220 may include monitoring one or more activities of the one or more sales leads and the at least one sales representative in real-time. In such embodiment monitoring the one or more activities of the one or more sales leads and the at least one sales representative may include monitoring the one or more activities of the one or more sales leads while communicating with the one or more sales leads in order to receive one or more sales orders.

Furthermore, the method 220 includes generating an optimal route plan for the at least one sales representative to reach the one or more sales leads based on the one or more properties in step 240. In one embodiment, generating an optimal route plan for the at least one sales representative may include generating an optimal route plan for the at least one sales representative based on at least one of the category, the availability of time, the experience of the at least one sales representative and the like.

In one exemplary embodiment, the method 220 may include enabling an assigner to view the generated optimal route plan. The method 220 may also include alerting or changing the optimal route plan based on one or more parameters of which may be considered by the assigner. In such an embodiment, the method 220 may further include generating a new optimal route plan based on the one or more parameters of which may be considered by the assigner.

The method 220 also includes fulfilling one or more sales orders by the at least one sales representative received from the one or more sales leads in step 250. In one embodiment, enabling the at least one sales representative to fulfill the one or more sales order received may include enabling the at least one sales representative to fulfill the one or more sales order upon utilising the optimal rout plan.

The method 220 also includes monitoring the one or more activities of the at least one sales representative on fulfilling the one or more sales order in real-time in step 260. In one embodiment, monitoring the one or more activities of the at least one sales representative may include monitoring the one or more activities of the at least one sales representative may include monitoring one or more means acquired by the at least one sales representative in order to fulfill the one or more sales orders.

Furthermore, the method 220 includes processing one or more reimbursement requests generated by the at least one sales representative in step 270. In one embodiment, processing the one or more reimbursement requests may include processing the one or more reimbursement requests based on one or more expenses which may be done by the at least one sales representative.

The method 220 also includes generating a notification upon processing the one or more reimbursement requests in step 280. In one embodiment, the notification may be generated for notifying an expense department in order to fulfill the one or more reimbursement requests of the at least one sales representative. Furthermore, based on a response from the expense department, the at least one sales representative may receive an acknowledgement for the one or more reimbursement requests.

In one exemplary embodiment, the method 220 may further include storing at least one of a plurality of details of the at least one sales representative, a plurality of details of the one or more sales leads, the optimal route plan, the one or more sales orders, the one or more reimbursement requests, or a combination thereof. In such embodiment, storing the plurality of details may include storing the plurality of details on a remote storage. In one embodiment, storing the plurality of details on the remote storage may include storing the plurality of details on a cloud storage.

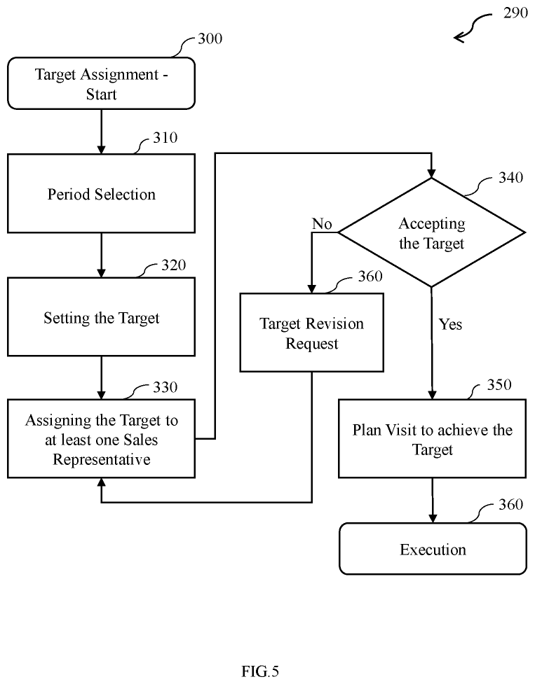

FIG. 5 is a flow chart representing steps involved in an exemplary method 290 for target assignment within an organization of FIG. 4 in accordance with an embodiment of the present disclosure. The method 290 for target assignment includes selection of period by a manager of an organisation upon starting the target assignment process in step 300 and 310. In one embodiment, selection of period may include selecting a time period between which the target may be completed.

The method 290 also includes setting a target by the manager upon selecting the period in step 320. In one embodiment, setting the target may include setting a plan in order to complete the target associated with the one or more sales leads. In such embodiment, the target may include data associated with revenue and number of orders.

The method 290 also includes assigning a set target to the at least one sales representative in order to enable the fulfillment of the target of completing the one or more sales orders received from the one or more sales leads in step 330. The method 290 also includes enabling the at least one sales representative to view the assigned target upon accepting the assigned target by the at least one sales representative in step 340 and 350. The method also includes executing the assigned target by the at least one sales representative for enabling the fulfillment of the one or more sales orders received by the one or more sales leads in step 360.

In one embodiment, the method 290 may include revising the assigned target to the at least one sales representative upon rejecting the assigned target by the at least one sales representative in step 360. In such a condition, the method 290 also includes reverting back for assigning the set target to the at least one sales representative in order to enable the fulfillment of the target of completing the one or more sales orders received from the one or more sales leads in step 360 and 330.

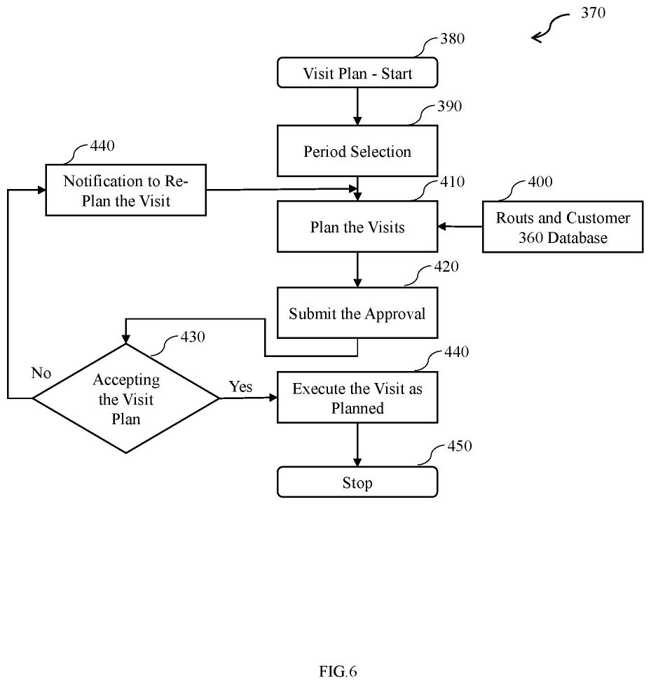

FIG. 6 is a flow chart representing steps involved in another exemplary method 370 for visit plan of FIG. 4 in accordance with an embodiment of the present disclosure. The method 370 for the visit plan within an organization includes selecting the period by the at least one sales representative upon starting the target assignment in step 380 and 390. The method 370 also includes receiving a route and one or more information associated to the one or more sales representative from a database in step 400. In one embodiment, the route and the one or more information may be used by the at least one sales representative to plan the visit. The method 370 also includes planning a visit by the at least one sales representative to the one or more sales leads to discuss an approach which may be implemented for fulfilling the one or more sales orders based on period selection, the route and the one or more information in step 410.

Furthermore, the method 370 also includes submitting the plan for visit by the at least one sales representative to a sales head in order to receive an approval for the plan in step 420. In one embodiment, the sales head may be a manager. The method 370 further includes visiting the one or more sales leads by the at least one sales representative for execution of the plan upon receiving the approval for the plan by the sales head in step 430 and 440. In one exemplary embodiment, the method 370 may further include generating a notification for re-planning the visit by the at least one sales lead upon receiving a rejection for the plan by the sales head and correspondingly stop the process of visit plan in step 430, 440 and 450.

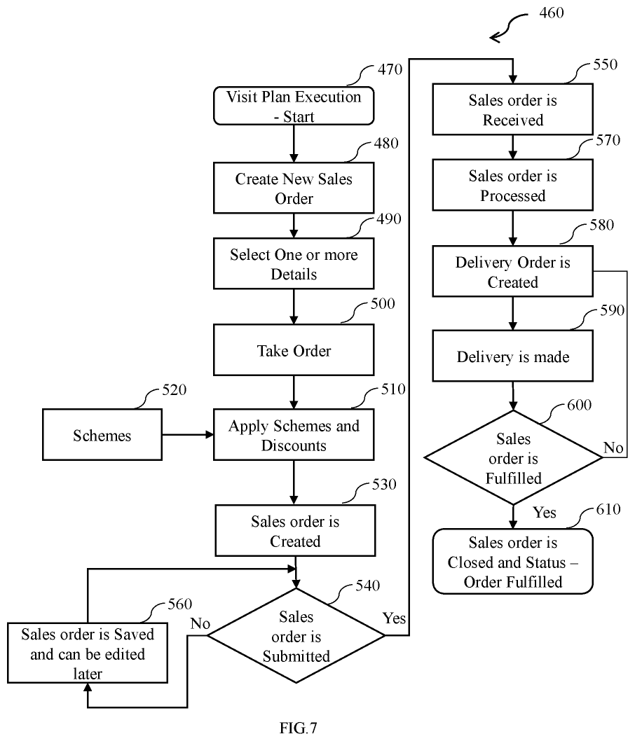

FIG. 7 is a flow chart representing steps involved in yet another exemplary method 460 for order fulfilling within the organization of FIG. 4 in accordance with an embodiment of the present disclosure. The method 460 includes creating a new sales order by the at least one sales representative upon execution of the plan on starting the execution of the visit plan, wherein the plan is in continuation with the description of FIG. 6 in step 470 and 480. The method 460 also includes selecting one or more details related to the one or more sales order of the one or more sales leads in step 490. In one embodiment, the one or more details includes sales price book for the associated one or more sales orders, shipping address of one or more sales leads, warehouse details and the like.

Furthermore, the method 460 includes taking the one or more sales order by the one or more sales leads in step 500. In one embodiment, the one or more sales orders may include one or more product types, number of unites required for the corresponding one or more product type, one or more service types, or the like. The method 460 also includes applying schemes and discounts on the one or more sales orders if applicable in step 510 and 520. In one embodiment, the schemes may include a line item, an order value and the like. The method 460 also includes creating the one or more sales order by the at least one sales representative in step 530. The method 460 also includes submitting one or more created sales order to the sales head in step 540. The method 460 also includes enabling a delivery team to receive the sales order upon submitting the created sales order in step 550. In one exemplary embodiment, the method 460 may further include resubmitting the sales order upon being edited when the sales order was not previously submitted by the at least one sales representative in step 560.

The method 460 also includes enabling the delivery team to proceed the sales order in step 570. The method 460 also includes creating a delivery order by the delivery team in step 580. The method 460 also includes delivering the one or more sales orders to the one or more sales leads in step 590. The method 460 also includes closing the one or more sales orders associated to the one or more sales leads upon fulfilling the one or more orders of the one or more sales leads and updating a status of the one or more orders by the at least one sales representative upon successful completion of the one or more sales orders in step 600 and 610. In one exemplary embodiment, the method 460 may further include recreating the delivery order when the one or more sales order is not fulfilled by the at least one sales representative in step 600 and 580. Consequently, the method may further include enabling the delivery team to update a status of the sales order as order fulfilled upon fulfilling the one or more orders in step 610.

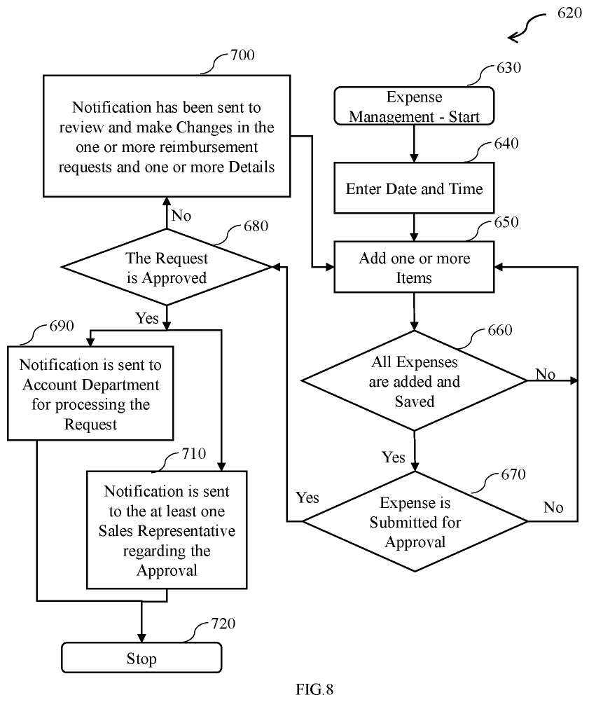

FIG. 8 is a flow chart representing steps involved in yet another exemplary method 620 for expense management within the organization of FIG. 4 in accordance with an embodiment of the present disclosure. The method 620 includes enabling the at least one sales representative to enter a date and time associated with the one or more reimbursement requests in order to manage expense of the organisation upon starting the expense management process in step 630 and 640. The method 620 also includes enabling the at least one sales representative to add one or more items with one or more details of the corresponding one or more items which has to be reimbursed by the at least one sales representative who may be in charge of the expense management in step 650. In one embodiment, the one or more details may include at least one of a category, total expense, type of occasion and one or more attachments representative of the expense caused during the fulfillment of the one or more orders. The method 620 also includes saving all the expenses upon being added in a database by the at least one sales representative in step 660.

Furthermore, the method 620 also includes submitting the expenses to the sales head to receive an approval for the one or more reimbursement requests of the at least one sales representative upon adding the same in the database in step 670. In one embodiment, the method 620 may further include enabling the at least one sales representative to re-add the one or more items with one or more details of the corresponding one or more items which has to be reimbursed by the at least one sales representative who may be in charge of the expense management upon not adding or saving the same in the database in step 660 and 650. In one exemplary embodiment, the method 620 may also include enabling the at least one sales representative to re-add the one or more items with one or more details of the corresponding one or more items which has to be reimbursed by the at least one sales representative upon not submitting the expenses to the sales head to receive the approval for the one or more reimbursement requests of the at least one sales representative in step 670 and 650.

Furthermore, the method 620 also includes enabling the sales head for approving the one or more reimbursement requests in step 680. The method 620 also includes sending a notification to an account department for processing the one or more reimbursement requests and simultaneously sending the notification to the at least one sales representative regarding the approval of the one or more reimbursement requests upon receiving the approval from the sales head in step 690. In one embodiment, the method 620 may include sending a notification to the at least one sales representative for reviewing and making changes in the one or more reimbursement requests and the one or more details upon receiving a rejection by the sales head for the approval of the one or more reimbursement request of the at least one sales representative in step 700. The method 620 also includes sending the notification for the at least one sales representative regarding the approval of the one or more reimbursement request in step 710. The method further includes stopping the expense management process upon sending the notification respectively in step 720

Various embodiments of the sales and distribution management platform and a method to operate the same enable the system to allow a user or an assigner to review the proposed route plan for an approval and re-planning the visit based the parameters. The system also enables the user or the assigner to receive and generate sales orders for the sales leads. Also, the computing device enables the user a process the expense reimbursement request.

In addition, as the system has a centralised platform, using and implementation of sales and distribution management is user friendly and also increases the efficiency of the system.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependant on other acts may be performed in parallel with the other acts. The scope of embodiments is by no means limited by these specific examples.

We claim:

1. A computing device comprising:
one or more processors;
a target assessment subsystem operable by the one or more processors, and configured to assign one or more sales leads to at least one sales representative based on one or more parameters;
a route plan subsystem operable by the one or more processors, and configured to generate an optimal route plan for the at least one sales representative to reach the one or more sales leads based on one or more properties;
an order fulfilling subsystem operable by the one or more processors, and configured to:
fulfill one or more sales orders by the at least one sales representative received from the one or more sales leads;
monitor one or more activities of the at least one sales representative on fulfilling the one or more sales order in real-time;
an expense management subsystem operable by the one or more processors 20, and configured to process one or more reimbursement requests generated by the at least one sales representative; and
a notification subsystem operable by the one or more processors, and configured to generate a notification to the at least one sales representative upon processing the one or more reimbursement requests.

2. The computing device as claimed in claim 1, wherein the one or more parameters comprises at least one of a category, availability of time, experience of the at least one sales representative or a combination thereof.

3. The computing device as claimed in claim 1, wherein the one or more processors is located on a remote server.

4. The computing device as claimed in claim 1, comprising a memory operatively coupled to the one or more processors, and configured to store at least one of a plurality of details of the at least one sales representative, a plurality of details of the one or more sales leads, the optimal route plan, the one or more sales orders, the one or more reimbursement requests, or a combination thereof.

5. A method for sales and distribution management comprising:
assigning, by a server computing device, one or more sales leads to at least one sales representative based on one or more parameters;
generating, by the server computing device, an optimal route plan for the at least one sales representative to reach the one or more sales leads based on one or more properties;
fulfilling, by the server computing device, one or more sales orders by the at least one sales representative received from the one or more sales leads;
monitoring, by the server computing device, one or more activities of the at least one sales representative on fulfilling the one or more sales order in real-time;
processing, by the server computing device, one or more reimbursement requests generated by the at least one sales representative; and
generating, by the server computing device, a notification to the at least one sales representative upon processing the one or more reimbursement requests.

6. The method as claimed in claim 5, wherein assigning the one or more sales leads to the at least one sales representative based the on one or more parameters comprises assigning the one or more sales leads to the at least one sales representative based at least one of a category, availability of time, experience of the at least one sales representative or a combination thereof.

7. The method as claimed in claim 5, storing, by a memory, at least one of a plurality of details of the at least one sales representative, a plurality of details of the one or more sales leads, the optimal route plan, the one or more sales orders, the one or more reimbursement requests, or a combination thereof.
